(19) United States
(12) Patent Application Publication
(10) Pub. No.: US 2010/0005476 A1
(43) Pub. Date: Jan. 7, 2010

(54) MOBILE ELECTRONIC DEVICE INCLUDING A PORTABLE APPLICATION AND A SECURED MODULE ABLE TO COMMUNICATE WITH EACH OTHER, AND ASSOCIATED COMMUNICATION METHOD

(75) Inventors: Stéphane JAYET, Meyzieu (FR); Didier MOYART, Lyon (FR)

Correspondence Address: YOUNG & THOMPSON, 209 Madison Street, Suite 500, Alexandria, VA, 22314, US

(73) Assignee: OBERTHUR TECHNOLOGIES, Levallois-Perret (FR)

(21) Appl. No.: 12/496,995

(22) Filed: Jul. 2, 2009

(30) Foreign Application Priority Data
Jul. 4, 2008 (FR) 0854579

(51) Int. Cl. G06F 9/46; G06F 21/00; G06F 15/16

(52) U.S. Cl. 719/311; 713/189; 709/219

(57) ABSTRACT

An electronic device (18) adapted to be removably connected to a host station (10), includes a portable application (242) adapted to be executed on the host station (10) and at least one secured module (26) interface (260), for example a smart card module, the device further includes an extension module (244), or plug-in, for the portable application (242), the extension module being adapted to establish communication with the secured module (26) via the interface (260) when the portable application (242) is executed on the host station (10). A corresponding method of communication between this portable application and the secured module is also disclosed.

This application claims priority from French patent application Ser. No. 08/54579 filed on Jul. 4, 2008, the entire contents of which are incorporated in the disclosure of the present application.

The present invention concerns an electronic device removably connectable to a host station and including a portable application and a secured module, for example a smart card module. The present invention is also directed to a corresponding method of communication between this portable application and the secured module.

Portable applications constitute a particular type of application widely used on removable media. These applications are particular in that they are executed on a host station, such as a computer or a mobile telephone device, receiving the removable media, without having to be installed on that host station beforehand. Thus they can be launched automatically on physical connection of the media to the host station, for example. Alternatively, they can be launched manually by the user.

The main portable application formats known in the art are U3 (SanDisk standard, registered name) and Framakey (open source software format). Accordingly, use of these portable applications is secured, without personal information being left on the host machines, in particular on the hard disks.

This portable application context is highly specific because, given that these applications do not leave any trace in the host machine, no parameter or configuration is available in the latter machines to set any additional tool parameters. Solutions valid for applications installed directly on a host machine therefore do not necessarily apply to the specific case of portable applications.

This mobility of applications responds in particular to a growth in the roaming requirements of computer users, who carry, in a simple USB (Universal Serial Bus) key, or other equivalent device, all of their data and applications, as well as specific data processing environments. Thus some traditional or standard applications, such as web browsers, word processors, spreadsheets and databases have been developed under the mobile format.

In the context of information technology convergence, there is a requirement for such applications to cohabit with secured modules similar to smart cards in the same removable connection mobile electronic device, such as a USB key, a multimedia card (MMC) or a secure digital (SD) card.

Here the secured modules are seen as electronic circuit portions that are secure according to certification criteria, such as the common criteria defined in the banking sector, in order to secure secret data, generally by using cryptographic protocols, for example using a private key/public key or an identity. This kind of module can in particular be a smart card associated with a card reader or simply a circuit integrated directly into the mobile electronic device.

Of particular interest are such removable electronic devices containing a standard portable application and secured module means.

This juxtaposition is not free of problems, especially if the standard portable application executed on the host station is required to communicate with the secured module, for example during a banking transaction authentication process.

These standard applications have not been developed to communicate with secured modules. Furthermore, any communication means (for example application-related communication means) provided in the host station for this purpose are generally dedicated and programmed to operate with applications installed directly on the same station, because a number of parameters are required for setting up the communication means. These means are then inappropriate to provide the required communication in the context of use of a portable application where such parameters are absent by definition.

The invention addresses this new problematic, aiming in particular to avoid laborious installation on the host station.

There is nevertheless known, in a recent implementation illustrated by the published document US 2008/0052770 or WO 2007/116277, so-called “host agent” software stored on a smart card and executed directly on the host station to which the smart card is connected. The latter also includes a secured module and associated “card agent” software. This “host agent” software has the particular feature of providing only means of communication between an application already installed on the host station, here a web browser, and the secured module via the “card agent”. The standard application, here the web browser, is installed on the host station.

However, this solution has the drawback of necessitating “host agent” software specific to the execution environment of the host station, such as its operating system, although that is not known at the time of configuring the mobile electronic device. This results in a limitation on the mobility (or roaming capability) of the removably connectable electronic device and the standard portable application that it contains.

The present invention therefore aims to alleviate the shortcomings of the prior art and, to that end, provides for the use of an extension module for the portable application, also known as a “plug-in”, to provide the means of communication with the secured module.

With this aim in view, the invention is directed in particular to an electronic device adapted to be removably connected to a host station, the device including a portable application adapted to be executed on said host station, at least one secured module interface, and an extension module, for example a plug-in, for said portable application, said extension module being adapted to communicate with said secured module via said interface when said portable application is executed on said host station.

A plug-in, or extension module, or in short an extension, for a particular application, is a non-autonomous program that is activated in the context of execution of the application and which interacts with the application to provide it with additional functions. The plug-in generally takes the form of scripts defining a set of additional functions for the application.

Being integrated with the application by appropriate mechanisms, for example instantiation as described hereinafter, the additional functions are accessible via the application. Accordingly, when the application is called to execute a function of the plug-in, it no longer generates an error, as it would in the absence of the plug-in, but accesses the code of the script corresponding to the requested function.

The invention provides the portable application of the removable device with a plug-in adapted to communicate with or to access the secured module of the mobile device, in particular using protocols provided for this purpose. Accordingly, the mobility of all functions of the removable mobile electronic device is limited only to that of the portable application, and not to that of the plug-in. It is consequently possible to use these functions on all host machines allowing execution of the portable application without the plug-in.

Furthermore, the same plug-in can be used for different versions of the standard application each adapted to a specific execution environment.

The solution proposed by the present invention also enables removable electronic device manufacturers to develop simply, and generally by themselves, components for communication between applications already on the market and their removable devices. They therefore have no need to call on the publishers of those applications.

In one embodiment, said portable application is a web browser. Alternatively, this application can be any standard office package, such as word processing, a spreadsheet or a database, as mentioned above.

In particular, said extension module includes at least one function in the form of script adapted to be called by a web page loaded into said portable application. This offers a simple way to automate access to the functions of the secured module.

According to one particular feature, said plug-in is instantiated, or loaded, on loading said web page using said function. Thanks to these features, use of the resources of the host station is optimized because all that is instantiated, and thus loaded into memory, is the plug-ins declared, and thus generally used, in the loaded web page. In particular this addresses the problem of the multiplicity of such plug-ins when they are generally not necessary for all uses.

To effect this instantiation, said web page includes a script for loading said extension module, for example in the form of a JavaScript™ function. Such declarations are then easy to implement at low cost given the improvement that can be achieved in terms of optimizing the resources of the host station.

In one embodiment of the invention, the device includes an automatic launch module, generally of autorun software type, adapted to launch execution of said portable application on said host station on connection of said device to the host station.

In one embodiment, the device includes a concentrator, for example a USB hub, to which is connected a first memory storing at least said portable application, and a secured module adapted to communicate via said interface and said concentrator, and thus in the present example to communicate to the USB standard.

In one selected architecture, the device includes a memory storing at least said portable application and a secured module connected to said interface, said memory and said secured module being integrated into two separate circuits, possibly interconnected, for example by means of the USB hub and a dedicated bus.

Alternatively, said memories and secured modules are carried by the same integrated circuit.

In an embodiment involving two separate circuits, said interface is a smart card reader. This configuration facilitates changing the smart card as the secured module in the device, in particular in order to address a large number of uses of the device.

In particular, the device includes a smart card type secured module connected to said reader, said smart card conforming to the ID-000 format of the ISO 7816 standard.

In the case of a secured module in the form of a circuit totally integrated into the mobile device, the interface can be reduced to a simple connection between that circuit and the other components of the device used to provide communication with the exterior of the mobile device.

According to one feature of the invention, said communication between the portable application executed on the host station and the secured module includes commands conforming to the ISO 7816 standard encapsulated in a communication protocol. This makes it possible to retain a standard language designed for secured modules, here APDU commands, whilst satisfying the classic standards governing exchanges between removable media and a host machine, here the USB protocol, for example. To this end, said interface includes means, preferably software means, adapted to encapsulate or de-encapsulate said APDU commands in or from data conforming to the communication protocol, in the present example the USB protocol.

One embodiment of the device includes a secured module connected to said interface, said secured module being secured in accordance with the common criteria or FIPS standard.

In one embodiment of the invention, the device includes a secured module connected to said interface and including cryptographic means.

In particular, the device includes a secured module connected to said interface, and said extension module and said secured module include corresponding cryptographic means adapted to conjointly establish secured communication between them. This can be a matter, for example, of private/public encryption keys accompanied by corresponding calculation means. There is obtained in this way, in addition to security at the level of the secured module, an enhanced degree of security during exchanges of data between the standard portable application and the secured module.

The invention also relates to a method of communication between a portable application, stored in an electronic device, and a secured module contained in said electronic device, the method including execution of said portable application on a host station to which said electronic device is removably connected, said portable application using at least one instruction. Furthermore:
the method includes loading at least one extension module for said portable application; and
said instruction calls at least one function of said extension module, said function being adapted to establish communication with said secured module.

As suggested hereinabove, the expression “module included in the device” refers to any module integrated directly into the device, generally by way of an integrated circuit, but also any module put into the device, for example via an ad hoc module reader.

In one embodiment of the invention, said portable application includes a web browser and the execution of at least one instruction includes loading by said web browser of a web page including an instruction calling said at least one function of said extension module. As indicated above, this embodiment using a web browser and associated web pages is particularly easy to implement, in terms of development and integration, in order to exploit functions of the secured module accompanying the portable application.

In particular, said web page includes a declaration of instantiation of said extension module and said loading of the extension module is effected when loading said web page by executing said instantiation declaration. As indicated above, this efficiently optimizes the use of the resources of the host station. Alternatively, instantiation can take place only after complete loading of the web page, for example when a JavaScript™ type function of the web page is executed, in particular by clicking on a button on that web page.

In one configuration of the invention, the method includes a step of automatically launching said portable application on insertion of said electronic device in said host station.

In one embodiment, the execution of said instruction generates a request to said secured module, for example a one-time password (OTP), a key or any other confidential information, said response to the request being displayed on the host station by said portable application.

Instead of this, or where appropriate in combination with it, said response to the request includes data and at least one target address of a remote server connected to the same communication network as said host station, the method then including execution of said response by the portable application so as to cause the sending of said data to the target address. This embodiment in particular makes it possible to automate, and therefore to speed up and make more efficient, a communication procedure, for example of authentication, of a user to a remote server. These exchanges can in particular be effected through http requests.

The method can optionally include features relating to the features of the device described above.

Other features and advantages of the invention will become more apparent in the following description, illustrated by the appended drawings, in which:

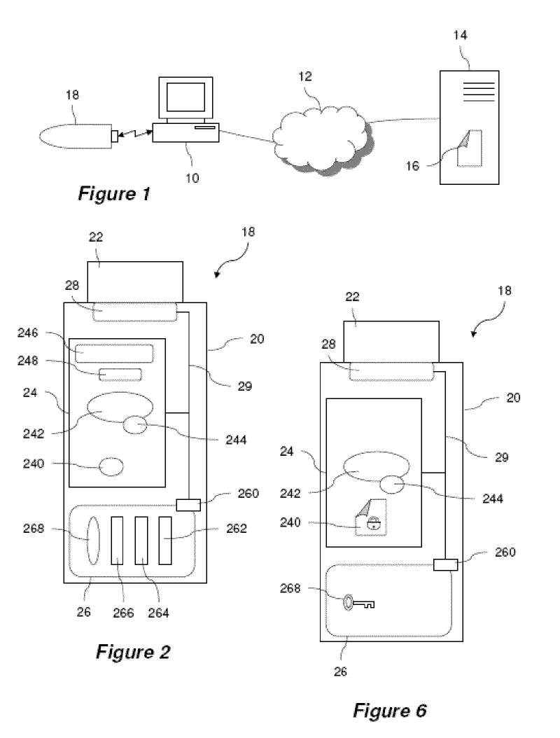

FIG. 1 represents a general view of a system for implementing the invention;

FIG. 2 represents a first example of an architecture of a mobile electronic device of the invention;

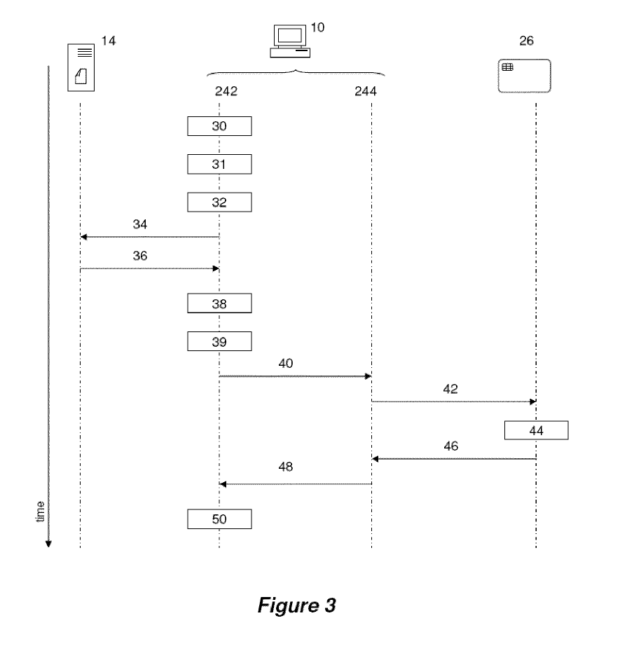

FIG. 3 illustrates the exchanges of messages between the various entities involved in the implementation of the invention according to FIG. 2;

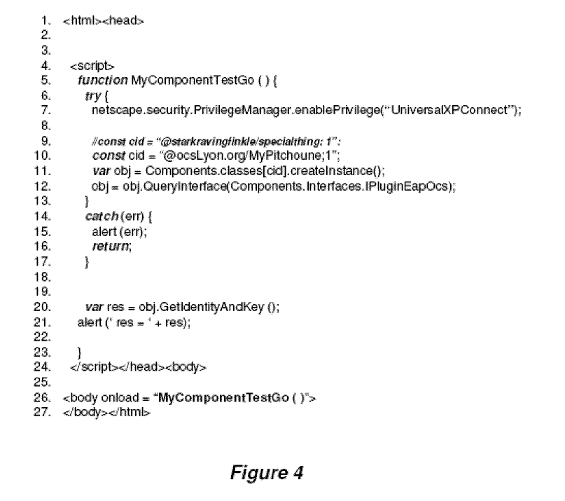

FIG. 4 represents a first example of an HTML web page supporting the exchanges from FIG. 3;

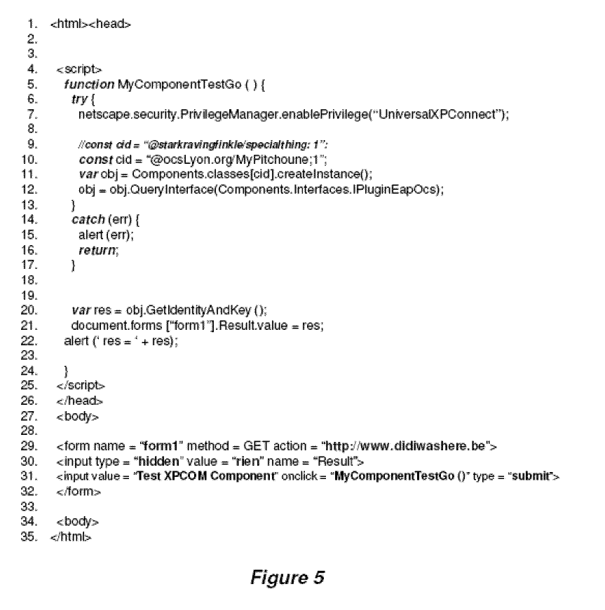

FIG. 5 represents a second example of an HTML web page supporting the exchanges from FIG. 3; and

FIG. 6 represents a second example of the organization of a mobile electronic device of the invention.

A first application of the invention using a standard portable application of web browser type is described with reference to FIGS. 1 to 5.

In FIG. 1 there is represented a system for implementing this first application.

A host station 10, here a personal computer with a USB port, is connected to a communication network 12, here the Internet, via which it communicates, for example using the hypertext transfer protocol (http), with a remote server 14.

Alternatively, the host station can be a mobile telephone, a personal assistant or generally speaking any device with processing capabilities and having an interface able to receive a mobile electronic device.

The remote server 14 stores, in memory, hypertext markup language (HTML) pages 16 constituting a web site to which a user requires access. This web site can be secured and necessitate authentication, for example by entering a password or a key.

On the user side, the latter has a mobile electronic device 18, here a USB key. Alternatively, this electronic device can be a multimedia card (MMC), an SD card or a smart card.

The USB key 18 can be removably connected to the personal computer 10 via a USB interface.

In FIG. 2 there is represented a first example of the architecture of a mobile electronic device of the invention, in particular for the application referred to above.

The USB key 18 includes a body 20 and a connector 22 adapted to cooperate with a corresponding USB connector provided on the host station 10.

In the body, the USB key 18 has a mass memory 24, for example of flash type, for standard data storage, a secured circuit module 26 and a concentrator or USB hub 28 to which are connected, on the one hand, the flash memory 24 and the secured circuit module 26, and, on the other hand, the USB connector 20.

The flash memory 24, or more precisely its controller, and the secured module 26 are adapted to communicate using the USB protocol, possibly using another protocol of higher level encapsulated by the data of said USB protocol. Thus communication with the personal computer 10 via the USB connector 20 is possible. Standard circuit or software means for implementing the USB protocol, possibly by encapsulating higher level protocols, can be used for this purpose.

Here the secured module 26 is a dedicated calculation circuit of the smart card type. Such a module 26 satisfies the evaluations of the secured circuits, for example according to the common criteria (corresponding to the ISO 15408 standard) at evaluation assurance level 4 (EAL4) or above, typically at level EAL4+.

There can be seen, in this module, an interface 260 on the USB bus 29 connecting to the hub 28, CPU type execution resources 262, non-volatile memory or read-only memory type memory means 264 and flash memory 266, and cryptographic means 268, where appropriate in the form of encryption and decryption programs and associated keys stored in the read-only memory 264.

In particular, this secured module 26 can receive APDU commands according to the ISO 7816 standard encapsulated in packets of the USB protocol. The interface 260 can in particular be dedicated to USB encapsulation (for transmission on the bus 29) and USB de-encapsulation (in the case of reception of data) of the APDU commands.

In one embodiment, said secured module 26 is an integrated circuit, likewise the USB key 18, so that it is seen by and functions in relation to the host station 10 as an integrated circuit(s) card device (ICCD).

Alternatively, said secured module 26 can be provided as a smart card within the conventional meaning. The smart card is then in particular of the ID-000 format according to the ISO 7816 standard, for example with the dimensions of a SIM (subscriber identity module) card used in mobile telephones. In this case, the interface 260 provided is of the smart card reader type. Whilst retaining the same USB key 18, and thus the data and applications stored in the memory 24, this configuration means that the secured modules can be changed, for example for different applications or for variable security levels. In this case, the smart card 26 functions in relation to the host station 10 as a circuit card interface device (CCID).

The mass memory 24 of the USB key 18 contains data 240 specific to the user and at least one standard portable application 242, here a portable web browser, for example Firefox™, to which a plug-in 244 has been added. According to the invention, this plug-in 244 includes software means, here functions defined by scripts, enabling access to the secured module 26 (or more precisely to its execution means). By way of example, these scripts are provided for generating APDU commands addressed to the secured module 26 in the USB key.

The memory 24 also contains means 246 for emulating a CD-ROM associated with an automatic application launcher program 248, also known as an autorun program, in particular for launching the application 242. This autorun program is loaded and executed automatically by the host station 10 on connection of the key 18.

By providing a file autorun.ini, well known to the person skilled in the art, in the memory 24, it is possible to launch the web browser 242 automatically as soon as the key 18 is connected to the host station 10.

It is understood that standard launching of the application 242 by the user via a dedicated interface of the host station 10 is envisaged as an alternative to the above or to be combined with it if a number of applications 242 are provided.

Examples of access to the web site hosted on the remote server 14 are described next with reference to FIGS. 3 to 5.

In FIG. 3 there are represented the exchanges of messages between the various entities involved in implementation of the invention.

In a first step, the above USB key 18 is connected to a USB port of the host station 10. The autorun.exe program is executed automatically, and reads the file autorun.ini which references the Firefox application 242. The latter is therefore launched and executed (30) by the host station 10 directly from its memory location in the key 18. For example, this execution generally uses a copy of the application in the random-access memory of the execution system of the host station 10.

In the step 32, there is a call for the web browser 242 to open the web page 16. This call can be manual, by the user entering an http address on an interface provided for this purpose. Alternatively, the http address can be stored in the memory 240 of the USB key, for example as a home page of the web browser.

In the step 34, the browser sends an http request, typically a GET request, to the web server 14, to obtain the required page 16.

In the step 36, the web server 14 transmits an http response to the request of the step 34 to the web browser 242. This response contains the HTML page 16.

A first example of an HTML page 16 including 27 lines is shown in FIG. 4.

In the step 38, the browser 242 executes and loads the HTML page 16 for its display if necessary.

Here loading is free of any display as suggested by the body of the HTML page in line 26 in FIG. 4. The on Load function triggers the MyComponentTestGo( ) method at the time of loading and executing the page.

This java script method includes a first phase (lines 6 to 13) for loading (step 39) the plug-in 244 necessary for the procedure to continue (lines 14 to 17 managing the exception return). A number of plug-ins can be provided for a given application 242. Thus some plug-ins are loaded and others not, as a function of their uses.

Here line 12 in FIG. 4 produces an instantiation of the plug-in named IPluginEapOcs, using the Composants.Interfaces component. Once this line of script has been executed, the plug-in 244 is loaded and the functions that it contains are available directly from the application 242. Note in particular that, even though the web browser and the plug-in are represented as being separate in FIG. 3, the latter is in fact executed in the browser in the conventional way for plug-ins.

In the step 40, loading of the web page 16 continues with execution of line 20 of the script calling the function or method GetIdentityAndKey( ) provided in the plug-in 242. This function is notably provided in script form in order to establish communication, even dialog, with the secured module 26.

Although this function has been represented without parameters here, there is generally provision for parameters, such as a code or an identification entered by the user, to be used by this function, in particular transmitted to the secured module 26 for calculation and authentication. The function is adapted to form a message or APDU commands for the attention of the secured module 26. Other formats or types of command can be used instead.

In the step 42, the plug-in generates an APDU command from any parameters entered in the function GetIdentityAndKey( ) and sends it to the secured module 26 via the USB channel formed of the USB port, the connector 22, the bus 29 internal to the key 18 and the interface 260.

In the step 44, the secured module 26 executes the APDU command received. For example, this can be a PIN (“Personal Identification Number”) verification, the generation of a one-time password (OTP), or the setting up of encrypted communication between the two entities by the exchange of keys or the encryption of a random number.

In the step 46, the secured module 26 returns to the plug-in 244 a response to the APDU command, for example a one-time password or an encrypted number.

In the step 48, this APDU-formatted response is recovered by the web browser 242 (because in the end it is the browser that executes the plug-in). Here, the response is contained in the variable res (see line 20 in FIG. 4), after extraction of the content of the APDU response by the functions of the plug-in.

In the step 50, the web browser 242 exploits the response res received. Here the response is displayed in a contextual alert window, as indicated in line 21 in FIG. 4.

Instead of or in combination with this, an http request can be sent back automatically by the web browser 242 to the server 14, this request being generated on the basis of the response res. For example, the secured identity of the user stored in the secured module 26, the one-time password or the encrypted number generated by the secured module 26 can here be sent back to the server 16, which after verification will enable the user to enter a secured portion of the web site that it hosts.

This automatic relaying of the password, encrypted number or any other information by the browser 242 to the web server 14 can be envisaged using, for example, a web server in the secured module, the APDU commands of the step 42 being incorporated into the http requests transmitted. For example, there can be provided for the step 42 an HTML page (encapsulated in a USB protocol if appropriate) addressed to the secured module 26 including:

<HTML>

<HEAD>

<TITLE>Encryption</TITLE>
<META http-equiv=“Refresh” content=
“1; URL=http://secured module/processAPDU?ID=123&

=09A52C6B7679”>

<HEAD>
<BODY> </BODY>

</HTML>

Accordingly, on loading of this page by the web server in the secured module 26, the APDU command indicated is transmitted to the execution means provided for this purpose, which then calculate the encrypted value of the number transmitted, here 09A52C6B7679 in hexadecimal.

The web server of the secured module 26 then sends back to the web browser 242 the following APDU format page:

<HTML>

<HEAD>

<TITLE>Encrypted number</TITLE>
<META http-equiv=“Refresh” content=
“1; URL=http:/remote server/access.cgi?ID=123&pwd

=672F9DD49000”>

<HEAD>
<BODY>Please wait, connecting...</BODY>

</HTML>

Accordingly, the result res=672F9DD49000 of the APDU command is received by the browser 242, which, given the Refresh function provided in the HTML script, transmits the encrypted value 672F9DD49000 to the remote server 14.

FIG. 5 gives a second example of an HTML page 16 including 35 lines, loaded by the browser 242 during the step 38.

In the step 38 itself, the browser 242 displays the form with the name form1 (see line 29) and including a button Test XPCOM Component (see line 30).

If the user clicks on said button, the method MyComponentTestGo( ) is called and executed (see line 31 specifying the onClick function).

The steps described above with reference to FIG. 4 are executed again until the result res is obtained in response to an APDU command generated by the function GetIdentityAndKey (line 20 of FIG. 5).

Note that this time the java script of the HTML page 16 continues on line 21 with the assignment of the result value res to the Result component of the form form1.

Furthermore, because here the submit applies to the button Test XPCOM Component, when the user has clicked on the latter, all of the form form1, including the result res, for example the identity “123@identity.org”, is submitted to the execution of the action defined by the form, here in line 29. Accordingly, this action commands the sending by the browser 242 of an http request (GET method defined in the syntax of the HTML forms) to the address specified in line 29: http://www.didiwashere.be/?Result=123@identity.org.

Referring now to FIG. 6, a second application of the invention is described using a standard word processing application such as Word™ The above description with reference to FIGS. 1 to 5 is equally applicable to this second application.

In this example, the USB key 18 stores a portable application 242 of word processor type, and a file 240 in the format of said software and encrypted with an encryption key 268. The word processor 242 has been augmented by a plug-in 244 giving it the function of sending requests to the secured module 26 in APDU command form, as described hereinafter.

For its part, the encryption key 268, which must be kept secret, is stored in the read-only memory 264 of the secured module 26.

If the user requires read mode access to the encrypted file 240, he connects the USB key 18 to the host station 10.

The word processor application 242, with its plug-in 244, is loaded into random-access memory and launched on the host station 10. Manual or automatic launching is envisaged. In this example, the plug-in 244 is automatically loaded, in a step 31 in FIG. 3, as soon as the application 242 launches (step 30 in FIG. 3).

The user then selects the encrypted file 240 to open using the word processor 242.

This selection causes the encrypted file 240 to be copied into the random-access memory of the host station 10.

Via its plug-in, the word processor 242 then communicates the encrypted file 240 to the secured module 26. This transmission can in particular be in the form of APDU commands encapsulated in the USB transmission protocol.

On reception of the corresponding APDU command, the secured module 26 accesses the encryption key 268 and, using standard key-based decryption processes, decrypts the file 240 received in the APDU command.

The file decrypted in this way is sent back, in response to the APDU command, to the word processor 242 executed on the host station 10, via its plug-in 244.

The decrypted file, which is therefore in the “clear” format for the application 242, is displayed by the latter on a screen of the host station 10. The user can thus access the data contained in the file 240, where appropriate to modify it.

It will be noted that the process of backing up the file modified in this way is similar to that described above except that the APDU command transmitted to the secured module 26 with the modified decrypted file is for encrypting the modified file. On reception of the encrypted modified file, the application 242 stores it in the conventional way in flash memory 24 of the USB key 18.

The above examples are merely embodiments of the invention, which is not limited to them.

In particular, the instantiation of the plug-in 244 of step 39 could be executed, rather than automatically on loading the web page 16, by action of the user, for example by selecting the button Test XPCOM Component. The HTML definition of the latter then specifies the method MyComponentTestGo( ) on a java script event, for example onClick( ) or on MouseOver( ).

1. Electronic device adapted to be removably connected to a host station, the device comprising a portable application adapted to be executed on said host station, at least one secured module interface, and an extension module for said portable application, said extension module being adapted to establish communication with said secured module via said interface when said portable application is executed on said host station.

2. Device according to claim 1, wherein said portable application includes a web browser.

3. Device according to claim 2, wherein said plug-in includes at least one function in script form adapted to be called by a web page loaded into said portable application.

4. Device according to claim 3, wherein said extension module is instantiated on loading said web page using said function.

5. Device according to claim 4, wherein said web page includes a script for loading said extension module.

6. Device according to claim 1, comprising an automatic launch module adapted to launch execution of said portable application on said host station when connecting said device to the host station.

7. Device according to claim 1, comprising a concentrator to which is connected a first memory storing at least said portable application and a secured module adapted to communicate via said interface and said concentrator.

8. Device according to claim 1, comprising a memory storing at least said portable application, and a secured module connected to said interface, said memory and said secured module being integrated in two separate circuits.

9. Device according to claim 1, comprising a memory storing at least said portable application, and a secured module connected to said interface, said memory and said secured module being carried on the same integrated circuit.

10. Device according to claim 1, wherein said interface is a smart card reader.

11. Device according to the preceding claim 10, comprising a secured module of smart card type connected to said reader, said smart card conforming to the ID-000 format according to the ISO 7816 standard.

12. Device according to claim 1, wherein said communication between the portable application executed on the host station and the secured module includes commands conforming to the ISO 7816 standard encapsulated in a communication protocol.

13. Device according to claim 1, comprising a secured module connected to said interface, said secured module being secured in accordance with the common criteria or the FIPS.

14. Device according to claim 1, comprising a secured module connected to said interface and comprising cryptographic means.

15. Device according to claim 14, wherein the extension module and the secured module include corresponding cryptographic means for setting up secured communication between them.

16. Method of communication between a portable application, stored in an electronic device, and a secured module contained in said electronic device, the method comprising:
executing said portable application on a host station, to which said electronic device is removably connected, said portable application using at least one instruction;
loading at least one extension module for said portable application; and
wherein said instruction calls at least one function of said extension module, said function being adapted to establish communication with said secured module.

17. Method according to claim 16, wherein said portable application includes a web browser and the execution of at least one instruction includes the loading, by said web browser, of a web page comprising an instruction calling said at least one function of said extension module.

18. Method according to claim 17, wherein said web page includes a declaration of instantiation of said extension module, and said loading of the plug-in is effected, during the loading of said web page, by the execution of said instantiation declaration.

19. Method according to claim 16, comprising a step of automatically launching said portable application on insertion of said electronic device in said host station.

20. Method according to claim 16, wherein the execution of said instruction generates a request sent to said secured module, said response to the request being displayed on the host station by said portable application.

21. Method according to claim 16, wherein the execution of said instruction generates a request sent to said secured module, said response to the request includes data and at least one target address of a remote server connected to the same communication network as said host station, the method comprising executing said response by the portable application so as to transmit said data to the target address.
